(19) United States
(12) Patent Application Publication
(10) Pub. No.: US 2013/0144801 A1
(43) Pub. Date: Jun. 6, 2013

(54) SYSTEM AND METHOD FOR IMPROVING THE EFFECTIVENESS OF SALES EFFORTS

(71) Applicants: Willam M. Marcum, Galloway, OH (US); Ryan P. Cox, Columbus, OH (US)

(72) Inventors: Willam M. Marcum, Galloway, OH (US); Ryan P. Cox, Columbus, OH (US)

(21) Appl. No.: 13/707,362

(22) Filed: Dec. 6, 2012

Related U.S. Application Data
(60) Provisional application No. 61/567,333, filed on Dec. 6, 2011.

(51) Int. Cl. G06Q 10/00

(52) U.S. Cl. CPC G06Q 10/00
USPC 705/345

(57) ABSTRACT

Disclosed embodiments describe a system and method for improving the effectiveness and efficiency of tracking and managing a canvassing sales force. The method provides a portal to: assign locations and territories; track the travel of sales people; input the disposition of a location; display the disposition (as well as other user identified data) of a location on a user-retrievable map; and edit the disposition and other location specific data for a location by a plurality of users. Team leaders may then assess the effectiveness of sales efforts and make more effective decisions regarding territory assignments (whether team wide or individual) and whether further canvassing is necessary.

This application claims the benefit of U.S. Provisional Application No. 61/567,333, filed Dec. 6, 2011, which is hereby incorporated by reference in its entirety.

### BACKGROUND AND SUMMARY OF THE INVENTION

Exemplary embodiments of the present invention are in the field of computer implemented sales tracking and more particularly in the field of real-time monitoring and mapping of sales and marketing efforts.

Conventional sales teams and their management have traditionally encountered a lag in information regarding the effectiveness of their marketing and canvassing efforts. This time-lag is due to the inevitable delays in employees reporting their efforts and experiences in the field. Thus, for example, sales team managers would assign territories or employees based on incorrect or outdated information about that territory and the sales or leads corresponding to it. The outdated-nature of this information was often the result of the time and difficulty involved in having employees fill out reports or waiting until monthly sales figures cross the manager's desk. In the case of the sales force, every minute they spend compiling reports regarding their efforts is a minute they do not have available for making sales. This is also true for reporting new leads. Capitalizing on new leads is a “strike while the iron is hot” business as delays allow competitors to scoop your efforts. Thus, any increase in speed or ease-of-use can make the difference between a missed sales lead and a new client.

The availability, low cost, and ubiquity of so-called smart-phones in everyday society creates an opportunity to leverage the capabilities of these devices to benefit sales forces. Many of the most recent mobile devices such as smart phones, etc. are equipped with GPS functionality, allowing the user to identify and transmit their position quickly. This coupled with easy web-based mapping allows the phone to identify the address of the location and to display publicly available information regarding the location (e.g., address, zip code, and, if a business, the name of the business).

These and other unmet needs of the known art may be met by exemplary embodiments of systems and methods of the present invention as described in more detail below.

For example, disclosed embodiments describe a computer-implemented system and method for more effectively tracking sales and marketing efforts. An exemplary embodiment of the method creates a user interface allowing a user to track his location, provide real-time information regarding the disposition of the location with respect to future sales efforts and the past efforts taken with respect to the location, and store and transmit this information. In an exemplary embodiment, the method may allow the user to capture information, such as the appearance of the location, through a camera of the device for a more complete portrait of the location.

In one embodiment, a user accesses a program and defines permission levels for a workgroup. The user then defines company specific data that will be input by canvassing sales people regarding the disposition of a location and other location specific data. In one example, the location specific data is tailored to gather information necessary for the goods/services that the company is selling and that are required to complete the work requested by customers.

In an exemplary embodiment, during operation, a user may download a program from the internet and then establish a group profile. The group profile may often be company specific. For example, the group profile may define the area of interest for the group, the desired dispositions that each location may be categorized under, and company specific data input fields that the group may use to further flesh out the details of each location. In one embodiment, if the company is for example a roofing company, non-limiting examples of company specific data input fields may include drop-down menus for users to select including, but not limited to: whether or not the structure has siding and if so what type or what color; whether or not the structure has gutters; is the roof shingled; and/or do they desire a different type of roof, etc. While these are examples of company specific data for one industry, it is expected that each company may have their own set of information that they collect for a location. As such, an embodiment of the system and method may allow the user to define these information fields to better tailor the information to its business needs.

In an exemplary embodiment, a user may define dispositions for the group for each assigned location. The dispositions, after being defined may then be applied to each location within a territory of interest for the company. The locations may then be allocated to primary users for appropriate contact based on the assigned disposition for that location. The primary user may access a network map via their mobile device. The device may show the company's map with dispositions of the locations denoted by, for example, colored icons. The user may then take appropriate action based on the disposition. For example, if a location is listed as open for first contact, a primary user may initiate contact with the location; if the location is listed as a past customer, the user may contact the location to follow up and inquire as to whether the location requires further goods or services; and/or if the location is listed as not needing goods/services for a specified time, the user may hold off on contact until the appropriate time, etc.

In an exemplary embodiment, during a sales call or after contacting a location, the user may input location specific data into a mobile device. The device may “sync” with a client sending the location specific data to the client for later access by the group. The location specific data may include: the disposition of the location; a picture of the location; drop-down menus for specific features of the location (siding type and color, do they have carpet or hardwood, etc.); and/or the current relevant goods/services used at the location (for example, if the salesperson is selling vacuum cleaners, what type is currently being used at the location, etc.) among others. An exemplary embodiment of the method contemplates allowing users to define the data that they would like their primary users to acquire in the field.

Moreover, in an exemplary embodiment, the users in the field may have the ability to edit the disposition of the location. For example, this may include denoting whether a sale was completed, whether the sales call was rebuffed or merely told to contact at a later date, etc. This disposition data may also be sent to the client and may be used by a secondary user to make real-time assignment/territory changes, and/or to receive quick updates regarding the effectiveness of a canvassing effort. The secondary user may then edit the disposition of a location or a group of locations, thus reassigning territories or changing assignments. In an exemplary embodiment, the disposition is displayed on a mobile device and shows an icon denoting the disposition of a location on a map. In one embodiment, the GPS capability of a mobile device allows the user to access a map via the downloaded method, and the map shows the current location of the user and their surrounding territory and displays the disposition of each location via an icon on the location. Further, the user may access additional location specific data from the mobile device. In one example, permissions allow a user to view all of the location specific data for a territory but to edit only the location specific data for the locations assigned to them. A secondary user, such as a manager, may be given permission to access, view, and edit the location specific data of all of the users for the company.

The system may also store the location specific data for later analysis. This analysis may include determining the overall effectiveness of the entire activity, and integrating this data with other territories to gather broader reaching effectiveness data. The assigned territory may be changed to account for the actual effectiveness of the user compared to the projected effectiveness before it was completed. If the user's efforts were more effective than projected, extra locations may be added to the assigned area, etc. In an exemplary embodiment, the user may be queried to decide how to change the assigned area, or the expert system may automatically change the assigned area.

In addition to the novel features and advantages of the exemplary embodiments mentioned above, other benefits will be readily apparent from the following descriptions of the drawings and exemplary embodiments.

### BRIEF DESCRIPTION OF THE DRAWINGS

FIG. 1 is a schematic diagram showing an exemplary embodiment of a system for performing a method of the present invention.

FIG. 2 is a flowchart showing an exemplary embodiment of a method the present invention.

### DETAILED DESCRIPTION

Conventional “canvassing” sales forces encounter substantial inefficiencies due to lags in communication between team members and between team members and team leaders. Often team members may accidentally overlap or miss territories due to miscommunications regarding assigned territories, unfamiliarity with a location, etc. This leads to wasted time by the team members, diminished goodwill on the part of potential customers due to multiple sales inquiries, as well as the possibility of missing potential leads entirely.

Exemplary embodiments of the present invention provide a system for displaying real-time location specific data on a mobile wireless device based on the data received from a user. In further embodiments, the message is tailored toward the information provided by multiple users and a workflow specific goal, specifically, the user entered disposition of a location.

Disclosed embodiments describe a computer-implemented system and method for increasing the workflow and response time for various work functions. In an exemplary embodiment, the system is designed to allow primary users such as salespeople to track and report their efforts and results in real-time, with these reports coupled to network-available mapping technology that may be retrieved by other members of their company. In one embodiment, a primary user, such as a salesperson, enables a downloadable application on a mobile device. The mobile device—via a satellite location capability—may then determine the position of the user and display the location of the user, either on an electronic map or a list of locations. The user may then input relevant location specific data into the mobile device, which may then transmit the location specific data to a client for storage and retrieval by the primary user or another member of a pre-defined workgroup.

Prior to entering location specific data, users may complete an enrollment process in which they provide information for a profile comprising location and user specified dispositions, which will be used to categorize and label the locations. In an exemplary embodiment, the user may access a website to navigate through the screens and provide data and information that allows the system to build a profile for the company and the users. In one example, a user may define a workgroup. The workgroup may, for example, comprise: primary users, those who will travel to locations and input the majority of the location specific data; secondary users, those who define territories and assign/reassign territories to primary users; system administrators who monitor and maintain the system; as well as other miscellaneous members with defined permissions. Each member in the workgroup may have access to a defined set of operations within the system.

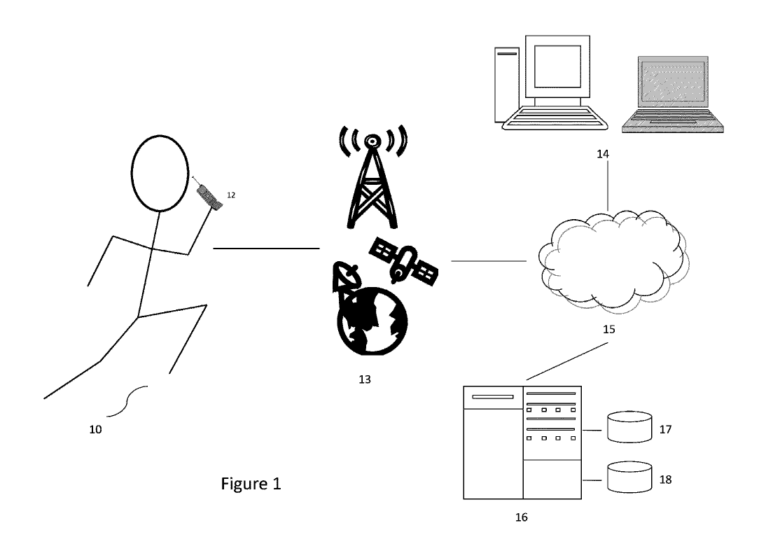

FIG. 1 is an illustration of the physical structure of a system according to an exemplary embodiment of the present invention. Connections between components permit data to flow in both directions. A laptop or desktop personal computer 14 is connected to a server 16 (or client) through the internet 15. The server 16 is connected to one or more databases 17, 18 comprising user data, such as disposition of a location, and other data as may be required to provide the features and functionality of the present invention. The server 16 is connected to communication networks 13 through the internet 15. The various communication networks 13 facilitate communications with a user 10 portable technology 12, which may include cellular or mobile phones, personal digital assistants, or any other portable device capable of sending and receiving communications through the communication networks 13. Based on the location specific data received by the system, the system stores and analyzes the data and sends a message to be displayed on a mobile device 12. The message is relayed through the communications network 13 and sent to the mobile device 12. The mobile device 12 may consist of any one of the following: cell phones, PDA's, Blackberrys™, iPhones™, any other portable device that is capable of receiving messages and displaying them for a user.

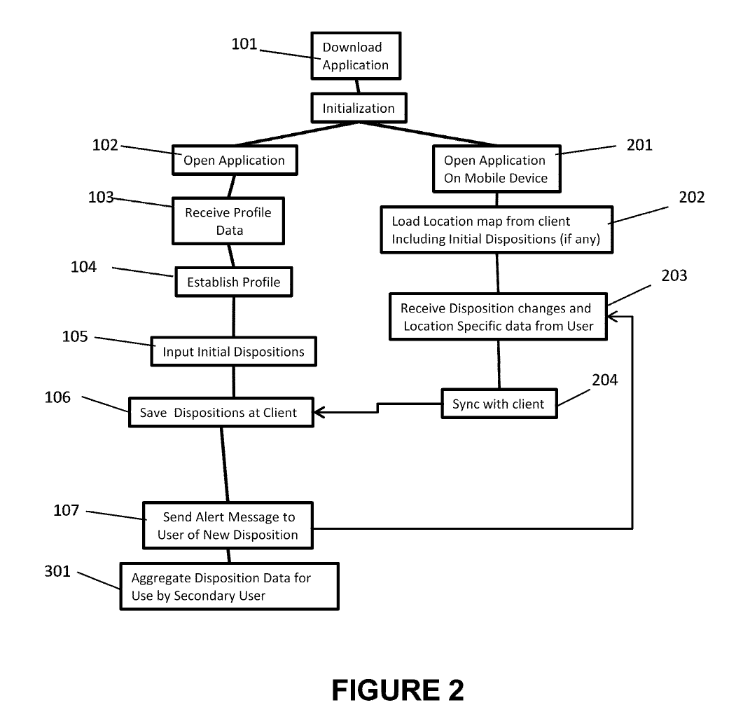

FIG. 2 shows a diagram of an exemplary embodiment of the system and method of the present invention. In this example, the left side of the diagram represents actions performed by members of the workgroup other than a canvassing salesperson, whereas the right side represents actions performed while canvassing or performed by the primary user. A user downloads the application 101 and initializes. Once the application opens 102, the user may input profile data 103 to establish a profile 104. The profile data may include data such as initial locations of interest, the workgroup definitions, the location specific data that the company would like to gather, disposition definitions, as well as others. Once the profile is established, a user may then input initial dispositions 105 or allow dispositions to be initially labeled by the primary users in a “free form” mode. These changes are saved at the client 106. If an initial disposition is entered, or a disposition is changed by a user, the system may then send an alert 107 to users of the change allowing them to alter their workflow accordingly. This may allow a sales person to respond to new assignments quickly, allowing a secondary user to alert and reassign several salespersons in one action. In an exemplary embodiment, after dispositions have been changed by primary users, the system may be adapted to aggregate 301 the changes and summarize changes for specific primary users across user-defined criteria such as how a user performs during specific times of the day, how a user performs in certain types of neighborhoods, etc., allowing supervisors to more easily evaluate each primary user.

On the right side of FIG. 2, a user (primary or secondary) downloads the application onto a mobile device 201. The application may then load and display a location map 202 from the client. The location map may be an assigned area or the area of interest for the entire company or a user defined area that has yet to be assigned. Along with the location map, the mobile device may retrieve and display dispositions from the client. Once loaded, the primary user may begin their canvassing efforts and input disposition changes and other location specific data 203 for the intended locations. As noted by the arrow, the application may send alerts to primary users of disposition changes made. This alert process may be made in real-time, alerting the primary user of related changes made and saved at the client, allowing them to change their workflow/destination accordingly. Iteratively, the application may “sync” 204 with the client while in operational communication with an appropriate data network. While outside of an appropriate data network, the mobile device may save the data received from the primary user since last sync, until communication with the client is restored; the device may then “sync” with the client.

The system may also store the location specific data for later analysis. This analysis may include determining the overall effectiveness of the entire activity, and integrating this data with other territories to gather broader reaching effectiveness data. The assigned territory may be changed to account for the actual effectiveness of the user compared to the projected effectiveness before it was completed. If the user's efforts were more effective than projected, extra locations may be added to the assigned area, etc. The user may be queried to decide how to change the assigned area or the expert system may automatically change the assigned area.

In an exemplary embodiment, a primary user may input location specific data into a mobile device. The mobile device may send the information to a client. The client may then allow other primary and secondary users to retrieve and view the location specific data.

During a sales call or after contacting a location, the user may input location specific data into a mobile device. The device may “sync” with a client sending the location specific data to the client for later access by the group. The location specific data may include: the disposition of the location; a picture of the location; drop-down menus for specific features of the location (siding type and color, do they have carpet or hardwood, etc.); and/or the current relevant goods/services used at the location (for example, if the salesperson is selling vacuum cleaners, what type is currently being used at the location, etc.); among others. An exemplary embodiment of the method contemplates allowing users to define the data they would like their primary users to acquire in the field.

Moreover, the users in the field may have the ability to edit the disposition of the location. This may include denoting whether a sale was completed, whether the sales call was rebuffed or merely told to contact at a later date, etc. This disposition data may also be sent to the client and may be used by a secondary user to make real-time assignment/territory changes, or to receive quick updates regarding the effectiveness of a canvassing effort. The secondary user may then edit the disposition of a location or a group of locations, thus reassigning territories or changing assignments. The disposition may be displayed on a mobile device and show an icon denoting the disposition of a location on a map. In an embodiment, the GPS capability of a mobile device may allow the user to access a map via the downloaded method. The map may show the current location of the user and their surrounding territory and display the disposition of each location via an icon on the location. Further, the user may access additional location specific data from the client via the mobile device. Optionally, permissions may allow a user to view all of the location specific data for a territory but to edit only the location specific data for the locations assigned to them. A secondary user, such as a manager may have permission to access, view, and edit the location specific data of all of the users for the company and can reassign territories or change dispositions (effectively opening-up or closing off locations) in real-time allowing for much more reactive sales efforts.

In an exemplary embodiment, during operation, a user may download a program from the internet and then establish a group profile. An example of the group profile may be company specific. The group profile may define the area of interest for the group, the desired dispositions that each location may be categorized under, and/or company specific data input fields that the group may use to further flesh out the details of each location, etc. In an embodiment, if the company is for example a roofing company, non-limiting examples of company specific data input fields may include drop-down menus for users to select including: whether or not the structure has siding and if so what type or what color; whether or not the structure has gutters; is the roof shingled; do they desire a different type of roof, etc. While these are examples of company specific data for one industry, it is expected that each company may have their own set of information that they collect for a location. As such, an exemplary embodiment of the system and method may allow the user to define these information fields to better tailor the information to their business needs.

An example of the profile further includes defining a workgroup. The workgroup may comprise those who may have permission to access the profile and to edit the corresponding data. Each user may be categorized based on their level of permission for accessing/editing the location specific data and the profile. In an exemplary embodiment, the permission levels may include: administrator level permission for maintaining the system; secondary user/company level permission for assigning territories and inputting and editing some location specific data; and/or primary user permission for accessing the system and inputting location specific data. It is expected that some companies may assign several levels of permission to the same user if the group is small or organized in a way that would make this the most logical assignment. The system and method contemplate a great deal of flexibility in the assignment of permissions as well as the definition of desired location specific data and dispositions for the locations.

An example of the profile may further include defining the levels and icons for the disposition of a location. In an embodiment, a company may define levels of disposition. Non-limiting examples of dispositions include: whether a location is open for access and has been assigned to a particular user to contact; whether or not the location has been contacted in the past; if the location has been contacted in the past, what was the outcome; the level of interest of the location; request for contact at a later time; is the location a past customer; has the location rebuffed contact in the past; has the location requested that the company cease contact in the future; and the preferred method of contacting the location, etc. As noted previously, an exemplary embodiment of the method contemplates providing significant flexibility to companies and their users to define their own criteria.

In an embodiment, the system and method may allow a user to assign a color to each defined disposition. The assigned color may then be displayed on an electronic map accessible to users via mobile devices. The selected color for the disposition may then be displayed on the map allowing users to quickly assess whether a location requires further attention, and if so, to provide quickly accessible information regarding what further attention might be required. Further, the disposition may be input and edited by both primary and secondary users allowing for real-time communication between those “in the field” and those at a brick and mortar location of the company, allowing managers to direct the efforts of their canvassing staff more effectively. Moreover, because the lag time of requiring primary users to report their efforts has been shrunk, the company may respond to customer interest more quickly. For example, if a primary user edits the disposition and location specific data of a location to denote that a sale has been initiated, other related logistics may be initiated by the company to prepare for meeting the customer demands without waiting for a formal sales report from the primary user. In an embodiment, a location may be assigned a color denoting that it is open for contact for any primary user. It may be given another color to denote that initial contact has been made but no sale was closed. Moreover, the colored icon denoting disposition may include the ability to display different levels of shading to denote which primary user has been assigned which location. For example, a user's device may display all of the assigned locations on one map, with those assigned to themselves displayed as opaque icons and those of their fellow team members as transparent icons. In this way, a user may quickly see an entire territory for the company but may easily distinguish between locations assigned to them from those assigned to other users.

In an aspect of the invention, a user other than a secondary user may assign an initial disposition to a location, or may be said to “collect dispositions” from the residents. In this “free form” aspect, the disposition is not set prior to the beginning of canvassing an area, rather in operation, the primary user solicits sales at locations that have yet to be specifically pre-assigned a designation. Thus, the primary user after making an initial solicitation may input an initial disposition for the subject location. For example, this aspect may be useful for an initial incursion into an area by a company.

In a further aspect of the invention, the computer-implemented method is adapted to display summaries of data for review by secondary users. In an embodiment, the summaries may display the effectiveness of a primary user based on zip code, time of day, etc. Moreover, the summary may be personalized to display the relative effectiveness of multiple primary users. This aspect may aid in the review and ranking of primary users by their superiors, and may be used to direct the efforts of specific users who may be shown to be more effective in certain general locations (an example is a user who shows good results in one type of neighborhood, say a neighborhood with mainly renters, versus bad results in another type of neighborhood).

The terms “a” and “an” and “the” and similar references used in the context of describing the disclosed embodiments (especially in the context of the following claims) are to be construed to cover both the singular and the plural, unless otherwise indicated herein or clearly contradicted by context.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the disclosed embodiments and does not pose a limitation on the scope of the disclosed embodiments unless otherwise claimed. No language in the specification should be construed as indicating any non-claimed element essential to the practice of the disclosed embodiments or any variants thereof.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability

Exemplary embodiments of this invention are described herein, including the best mode known to the inventors for carrying out the invention(s). Of course, variations on the disclosed embodiments will become apparent to those of ordinary skill in the art upon reading the foregoing description. The inventors expect skilled artisans to employ such variations as appropriate, and the inventors intend for the invention(s) to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosed embodiments unless otherwise indicated herein or otherwise clearly contradicted by context.

Having shown and described embodiments of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. A method for improving sales efforts comprising:
providing a computer-implemented application;
providing at least one mobile device adapted to be in communication with said application;
establishing a profile in said application related to at least one area of interest related to sales efforts; and
inputting at least one disposition defined in said profile;
wherein said mobile device is adapted to be informed of said disposition.

2. The method of claim 1 wherein said at least one mobile device is selected from the group consisting of cell phones and PDAs.

3. The method of claim 1 wherein the step of establishing said profile comprises defining a workgroup of users.

4. The method of claim 3 wherein the step of defining said workgroup comprises defining permission levels for said users to access and edit said profile.

5. The method of claim 1 wherein said profile includes at least one input field to track sales efforts with respect to at least one location.

6. The method of claim 5 wherein said at least one input field is adapted to provide at least one desired disposition for a sales location.

7. The method of claim 1 wherein said profile identifies sales locations of interest.

8. The method of claim 1 wherein said at least one mobile device is adapted to input said at least one disposition in said profile.

9. The method of claim 1 wherein said at least one mobile device is adapted to be synced with said application such that disposition data related to a location is updated.

10. The method of claim 1 wherein:
said mobile device enables a user to identify a location; and
said mobile device is adapted to display disposition data related to said location.

11. The method of claim 10 wherein said mobile device is adapted to display a location map that facilitates identification of said location.

12. The method of claim 11 wherein said map is adapted to show color that indicates disposition status at a location.

13. The method of claim 1 wherein said application is adapted to send alerts to said at least one mobile device regarding changes in disposition.

14. The method of claim 1 wherein said application is adapted to aggregate changes in disposition for subsequent analysis.

15. A system for improving sales efforts comprising:
a computer adapted to implement an application, said application adapted to provide a profile related to at least one area of interest related to sales efforts;
at least one database associated with said computer, said at least one database adapted to store disposition data related to said profile; and
at least one mobile device adapted to be in communication with said application;
wherein said at least one mobile device is adapted to display disposition data related to a sales location.

16. The system of claim 15 wherein said at least one mobile device is selected from the group consisting of cell phones and PDAs.

17. The system of claim 15 wherein said at least one mobile device is adapted to input disposition data related to a sales location.

18. The system of claim 15 wherein said at least one mobile device is adapted to be synced with said application such that disposition data related to a location is updated.

19. The system of claim 15 wherein:
said mobile device enables a user to identify a location; and
said mobile device is adapted to display disposition data related to said location.

20. The system of claim 15 wherein:
said application is adapted to send alerts to said at least one mobile device regarding changes in disposition; and
said application is adapted to aggregate changes in disposition for subsequent analysis.
